(19) United States
(12) Patent Application Publication
(10) Pub. No.: US 2008/0161017 A1
(43) Pub. Date: Jul. 3, 2008

(54) MOBILE APPARATUS, GEOGRAPHICAL INFORMATION SYSTEM AND METHOD OF ACQUIRING GEOGRAPHICAL INFORMATION

(75) Inventor: HSIN-YI TU, KAOHSIUNG COUNTY (TW)

Correspondence Address: ROSENBERG, KLEIN & LEE, 3458 ELLICOTT CENTER DRIVE-SUITE 101, ELLICOTT CITY, MD, 21043, US

(73) Assignee: MITAC INTERNATIONAL CORP., TAOYUAN (TW)

(21) Appl. No.: 11/961,141

(22) Filed: Dec. 20, 2007

(30) Foreign Application Priority Data
Dec. 29, 2006 (TW) 095150028

(51) Int. Cl. H04Q 7/20

(52) U.S. Cl. 455/456.3

(57) ABSTRACT

A mobile apparatus, a geographical information system and a method of acquiring geographical information are disclosed. The geographical information system is used for acquiring geographical information of a geographical object. The system at least includes a geographical object message and a mobile apparatus. The geographical object message is provided by the geographical object. The geographical object is generally an identification code or an image. The mobile apparatus is used for receiving the geographical object message, and generating an inquiry command after identifying the geographical object. Geographical information corresponding to the inquiry command is searched from a database of the mobile apparatus based on the inquiry command. The searched geography information is displayed on the mobile apparatus. The invention provides a direct viewing of geographic information for users to improve the degree of freedom of a trip and effectively manage personal time.

### FIELD OF THE INVENTION

The present invention relates to a mobile apparatus, a geographical information system and a method of acquiring geographical information, and more particularly to those acquiring related geographical information and services by a geographical object message.

### BACKGROUND OF THE INVENTION

As our living standard improves drastically in recent years, people pay more attention to leisure activities, and taking a trip becomes one of the major leisure activities. To ensure consumers to have a successful trip, various different means are developed, such as global positioning system (GPS). GPS was originally intended for military purpose, but now it is used extensively in civil navigation due to its practicability. On the other hand, consumers who go out for a trip generally need a tourist guide for providing information on scenic spots and related routes.

A terminal of a conventional global positioning system can position an object or a place on a map based on the wireless signal from a plurality of GPS satellites and provide a map related hint function, wherein the hint function produces a hint signal for each location by comparing a positioning signal and a data stored in the terminal and displays the hint signal on the map.

Although the conventional global positioning system can provide navigation and positioning functions, users cannot acquire their desired information from a direct viewing. In view of the shortcomings of the prior art, the inventor of the present invention based on years of experience to conduct extensive researches and experiments, and finally developed a mobile apparatus, a geographical information system and a method of acquiring geographical information in accordance with the present invention. Derived from the traditional concept of hinting a fixed point, the present invention provides users the required geographical information. Therefore, a user taking a trip no longer needs the service of a tourist guide to enjoy the scenic spots, and the present invention definitely improves the degree of freedom of a trip and effectively manages personal time.

### SUMMARY OF THE INVENTION

An objective of the present invention is to provide a mobile apparatus, a geographical information system and a method of acquiring geographical information, and more particularly to related geographical information and services acquired by a geographical object message.

To achieve the foregoing objective, the invention provides a geographical information system for acquiring geographical information of a geographical object, and the system comprises a geographical object message and a mobile apparatus, wherein the geographical object message is provided by the geographical object, which is usually an identification code or an image. After the mobile apparatus receives and identifies the geographical object message, the mobile apparatus generates an inquiry command. The geographical information corresponding to the inquiry command is searched from a database of the mobile apparatus based on the inquiry command to display the searched geographical information on the mobile apparatus.

To achieve the foregoing objective, the present invention also provides a geographical information system for acquiring geographical information of a geographical object, and the system comprises a geographical object message, a mobile apparatus and an information center, wherein the geographical object message is provided by the geographical object, and can be an identification or an image. After the mobile apparatus receives and identifies the geographical object message, the mobile apparatus generates an inquiry command, and sends out the inquiry command by a communication module of the mobile apparatus. After the information center receives the inquiry command, the information center searches the geographical information corresponding to the inquiry command and sends the searched geographical information to the mobile apparatus for display.

To achieve the foregoing objective, the present invention further provides a mobile apparatus comprising a device body, a database, a capture identification module, a communication module and a processor. The device body provides basic operating functions for the mobile apparatus, and the database, the capture identification module, the communication module and the processor are installed in the device body. The database stores the geographical information of at least one geographical object. The capture identification module acquires the geographical object message of the geographical object from outside and identifies the geographical object message to generate an inquiry command. The communication module is provided for sending the inquiry command and obtains the geographical information from outside. After the processor receives and processes the inquiry command, the processor transmits the inquiry command to the database to search the geographical information corresponding to the inquiry command, or the processor transmits the inquiry command to the communication module.

From the foregoing objective of the present invention, the invention derives a method of acquiring geographical information that is applied to a mobile apparatus for displaying geographical information, and the method comprises the steps of: acquiring a geographical object message of a geographical object from outside; generating an inquiry command after the geographical object message is identified; searching geographical information corresponding to the inquiry command from a database based on the inquiry command or searching geographical information corresponding to the inquiry command from an information center based on the inquiry command; and displaying the geographical information on the mobile apparatus.

In summation of the description above, the present invention adopts the geographical object message to provide a direct viewing of the user's required geographical information and related services, and improve the degree of freedom of a trip and effectively manage personal time.

To make it easier for our examiner to understand the objective of the invention, its structure, innovative features, and performance, we use a preferred embodiment together with the attached drawings for the detailed description of the invention.

### BRIEF DESCRIPTION OF THE DRAWINGS

FIG. 1 is a schematic view of a geographical information system in accordance with the present invention;

FIG. 2 is a schematic view of a geographical information system in accordance with a first preferred embodiment of the present invention;

FIG. 3 is a schematic view of a geographical information system in accordance with a second preferred embodiment of the present invention;

FIG. 4 is a schematic view of a geographical information system in accordance with a third preferred embodiment of the present invention;

FIG. 5 is a schematic view of another geographical information system of the present invention;

FIG. 6 is a schematic view of another geographical information system in accordance with a first preferred embodiment of the present invention;

FIG. 7 is a schematic view of another geographical information system in accordance with a second preferred embodiment of the present invention;

FIG. 8 is a schematic view of another geographical information system in accordance with a third preferred embodiment of the present invention;

FIG. 9 is a schematic view of a mobile apparatus of the present invention;

FIG. 10 is a flow chart of a method of acquiring geographical information of the present invention; and

FIG. 11 is a flow chart of a method of acquiring geographical information in accordance with a preferred embodiment of the present invention.

### DETAILED DESCRIPTION OF THE PREFERRED EMBODIMENTS

In the related figures of preferred embodiments of a mobile apparatus, a geographical information system and a method of acquiring geographical information of the present invention, the same referring numerals are used for the same components in accordance with the present invention.

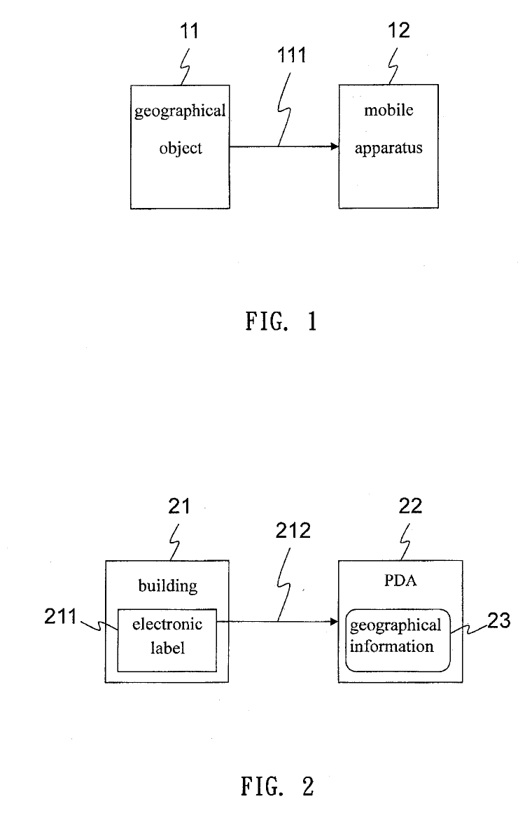

Referring to FIG. 1 for a schematic view of a geographical information system, the geographical information system is provided for acquiring geographical information of a geographical object 11, and the system comprises a geographical object message 111 and a mobile apparatus 12, wherein the geographical object message 111 is provided by the geographical object 11. The mobile apparatus 12 generates an inquiry command after the geographical object message 111 is received and identified. The geographical information corresponding to the inquiry command is searched from a database (not shown in the figure) of the mobile apparatus 12 based on the inquiry command, and the searched geographical information then is displayed on the mobile apparatus 12.

The geographical object is generally a building or transportation, and the transportation can be a public transit such as a bus. The geographical information is generally information relative to the geographical object such as the floor distribution, building feature, building history, nearby traffic, current position of a bus, and bus route, etc. The geographical object message is an identification code or an image, and the identification code is usually a combination of character strings or a barcode, and the geographical object message is usually transmitted by an electronic label installed in the geographical object to the mobile apparatus through a radio frequency signal. The image of the geographical object, such as its appearance, is usually photographed by a built-in photography module of the mobile apparatus, and taken as the geographical object message. Further, the geographical object message of the identification code can be obtained from Internet or a short message, and provided for users to understand the related geographical information in advance. The mobile apparatus is generally a mobile electronic apparatus, and more specifically a personal digital assistant or a mobile communication apparatus. T he mobile apparatus further comprises a radio frequency reader for receiving a geographical object message transmitted by a radio frequency signal, or comprises a photography module for photographing an image of a geographical object and taking the image as the geographical object message provided by the geographical object, or comprises a communication module for obtaining the geographical object message from Internet or a short message through a wireless communication. In the meantime, the mobile apparatus further comprises an identification unit for identifying the geographical object message of the geographical object from outside to generate an inquiry command, and the identification unit is provided for decoding signals and comparing the decoded signals, or the identifying and comparing images. Besides, the mobile apparatus further comprises a navigation module for generating at least one guided route based on the geographical object message. The navigation module comprises an electronic component such as a global positioning system chip for providing a navigation function. The navigation function can be executed based on the geographical information such as longitude and latitude, POI name, the detail addresses, phone numbers and so on. The database is generally a storage module for storing information related to the geographical object, such as the floor distribution, building feature, building history, nearby traffic, current position of a bus, and bus route, etc or storing a lookup table of the geographical information and the inquiry command.

Referring to FIG. 2 for a schematic view of a geographical information system in accordance with a first preferred embodiment of the present invention, the geographical information system comprises an identification code 212 of a building 21 and a personal digital assistant (PDA) 22, wherein the building 21 installs an electronic label 211 for transmitting the identification code 212 of the building 21, and the personal digital assistant 22 generates an inquiry command after the identification code 212 is received and identified, and the geographical information 23 corresponding to the inquiry command is searched from a database built in the personal digital assistant 22 based on the inquiry command to display the searched geographical information 23, such as the floor distribution, building feature, building history and nearby traffic, on the personal digital assistant 22.

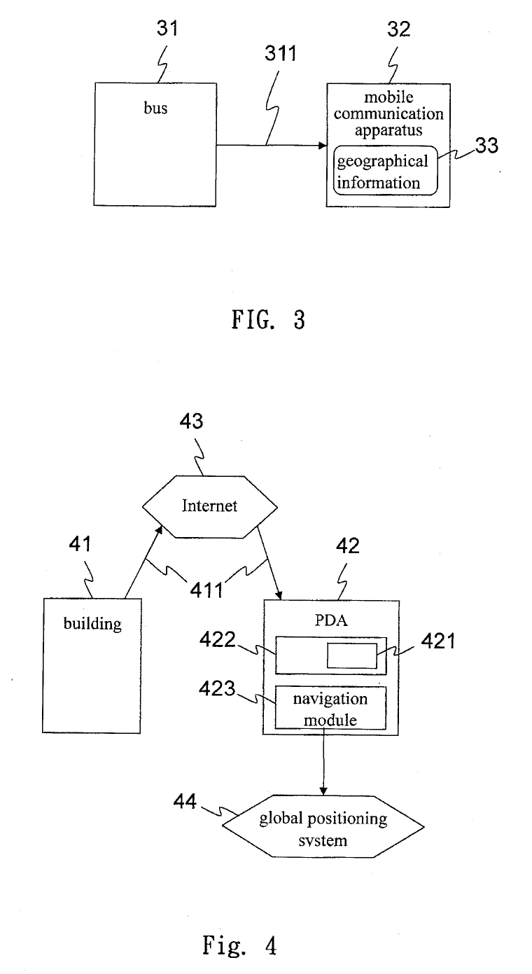

Referring to FIG. 3 for a schematic view of a geographical information system in accordance with a second preferred embodiment of the present invention, the geographical information system comprises an image 311 for the appearance of a bus 31 and a mobile communication apparatus 32, wherein the image 311 of the appearance of the bus 31 is photographed by a built-in photography module of the mobile communication apparatus 32. After the mobile communication apparatus 32 receives the image 311 of the appearance of the bus 31 and identifies the bus number of the bus 31 in the image 311, an inquiry command is generated, and the geographical information 33 corresponding to the inquiry command is searched from a database built in the mobile communication apparatus 32 based on the inquiry command. The mobile communication apparatus 32 then displays the searched geographical information 33 such as the bus route, and the departure time of the bus.

Referring to FIG. 4 a schematic view of a geographical information system in accordance with a third preferred embodiment of the present invention, the geographical information system comprises an identification code 411 of a building 41 and a personal digital assistant 42, wherein the identification code 411 of the building 41 is obtained by the personal digital assistant 42 from Internet 43, and the related geographical information 421 searched from a database 422 of the personal digital assistant 42 allows users to understand the building 41. According to the map information in the searched geographical information 421, a navigation module 423 installed in the personal digital assistant 42 is utilized to generate at least one guided route through a global positioning system 44 so that a user then is guided to reach the designated building 41.

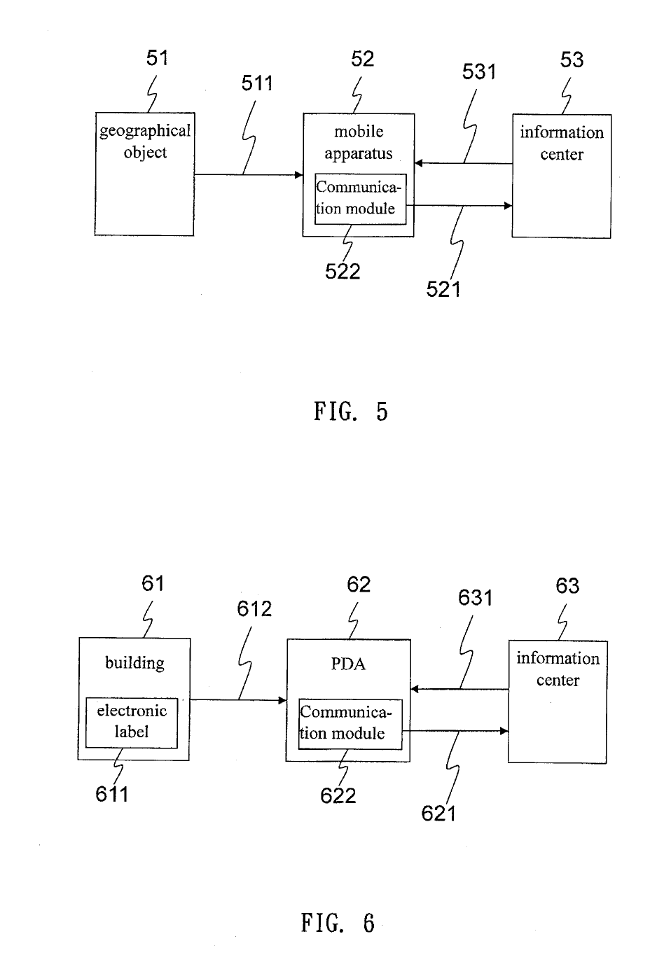

Referring to FIG. 5 for a schematic view of another geographical information system of the present invention, the geographical information system is provided for acquiring geographical information 531 of a geographical object 51, and the system comprises a geographical object message 511, a mobile apparatus 52 and an information center 53, wherein the geographical object message 511 is provided by the geographical object 51. The mobile apparatus 52 generates an inquiry command 521 after the geographical object message 511 is received and identified, and a communication module 522 of the mobile apparatus sends out the inquiry command 521. After receiving the inquiry command 521, the information center 53 searches the geographical information 531 corresponding to the inquiry command 521 and sends the searched geographical information 531 to the mobile apparatus 52 for displaying.

The geographical object is generally a building or transportation, and the transportation can be a public transit such as a bus. The geographical information is generally information relative to the geographical object, such as the floor distribution, building feature, building history, nearby traffic, current position of a bus, and bus route, etc. The geographical object message is an identification code or an image, and the identification code is generally a combination of character strings or a barcode, and the geographical object message is generally sent by an electronic label installed in the geographical object to the mobile apparatus through a radio frequency signal. The image is generally the appearance of the geographical object photographed by a built-in photography module of the mobile apparatus, and taken as the geographical object message. Further, the geographical object message of the identification code can be obtained via Internet or a short message, so that users can understand the related geographical information in advance. The mobile apparatus is generally a mobile electronic apparatus, and more specifically a personal digital assistant or a mobile communication apparatus. The mobile apparatus further comprises a radio frequency reader for receiving the geographical object message transmitted by the radio frequency signal. Besides, the mobile apparatus also comprises a photography module for photographing the image of the geographical object and taking the image as the geographical object message provided by the geographical object. The mobile apparatus also comprises a communication module for obtaining the geographical object message from Internet or a short message via a wireless communication. Meanwhile, the mobile apparatus comprises an identification unit for identifying the geographical object message of the geographical object from outside to generate the inquiry command, and the identification unit can execute the decoding and comparison for signals or the identification and comparison for images. The mobile apparatus further comprises a navigation module for generating at least one guided route based on the geographical object message. The navigation module comprises an electronic component such as a global positioning system chip for providing a navigation function. The navigation function can be executed based on the geographical information such as longitude and latitude, POI name, the detail addresses, phone numbers and so on. The information center generally comprises a geographical information system (GIS) for providing geographical information corresponding to the inquiry command, and the geographical information system stores information related to the geographical object, such as the floor distribution, building feature, building history, nearby traffic, current position of a bus, and bus route, etc. or stores a lookup table of the geographical information and the inquiry command.

Referring to FIG. 6 for a schematic view of another geographical information system in accordance with a first preferred embodiment of the present invention, the geographical information system comprises an identification code 612 of a building 61, a personal digital assistant 62 and an information center 63, wherein the building 61 includes an electronic label 611 for sending the identification code 612 of the building 61, and the personal digital assistant 62 generates an inquiry command 621 after the identification code 612 is received and identified, and a built-in communication module 622 of the personal digital assistant 62 sends out the inquiry command 621 based on the inquiry command 621, and after the information center 63 receives the inquiry command 621, the information center 63 searches the geographical information 631 corresponding to the inquiry command 621 and sends the searched geographical information 631, including the floor distribution, building feature, building history, and nearby traffic, to the personal digital assistant 62 for displaying.

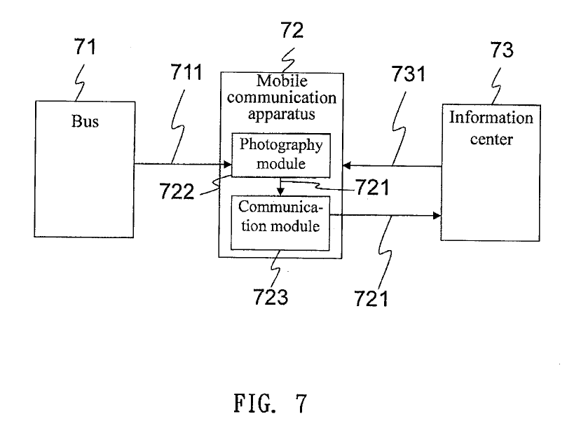

Referring to FIG. 7 for a schematic view of another geographical information system in accordance with a second preferred embodiment of the present invention, the geographical information system comprises the appearance of a bus 71, a mobile communication apparatus 72 and an information center 73, wherein an image 711 of the appearance of the bus 71 is photographed by a built-in photography module 722 of the mobile communication apparatus 72, and the mobile communication apparatus 72 generates an inquiry command 721 after the image 711 of the appearance of the bus 71 is received and the bus number of the bus 71 of the image 711 is identified, and a communication module 723 of the mobile communication apparatus 72 sends out the inquiry command 721 to the information center 73. The information center 73 searches the geographical information 731 corresponding to the inquiry command 721 after the inquiry command 721 is received, and sends the searched geographical information 731, such as the route of the bus 71 and the departure time of the bus 71, to the mobile communication apparatus 72 for displaying.

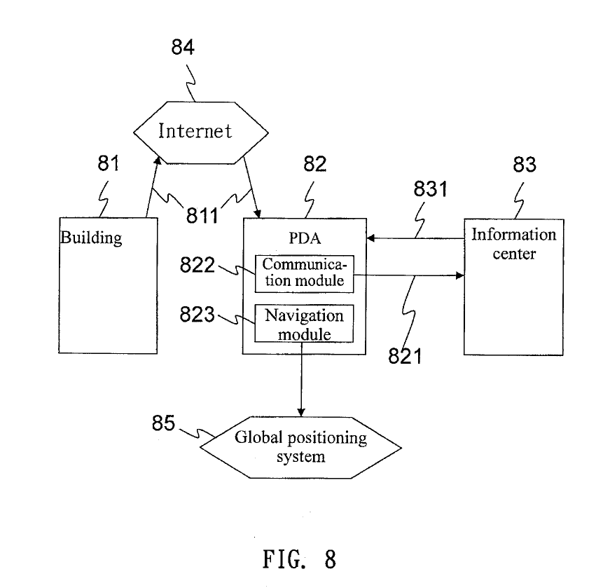

Referring to FIG. 8 for a schematic view of another geographical information system in accordance with a third preferred embodiment of the present invention, the geographical information system comprises an identification code 811 of a building 81, a personal digital assistant 82 and an information center 83, wherein the identification code 811 of the building 81 is obtained from the personal digital assistant 82 via Internet 84, and a communication module 822 of the personal digital assistant 82 sends an inquiry command 821 to the information center 83 to obtain geographical information 831, so that users can understand the related geographical information 831. According to a map information of the geographical information 831, a navigation module 823 installed in the personal digital assistant 82 generates at least one guided route by using a global positioning system 85 to guide users to reach a designated building 81.

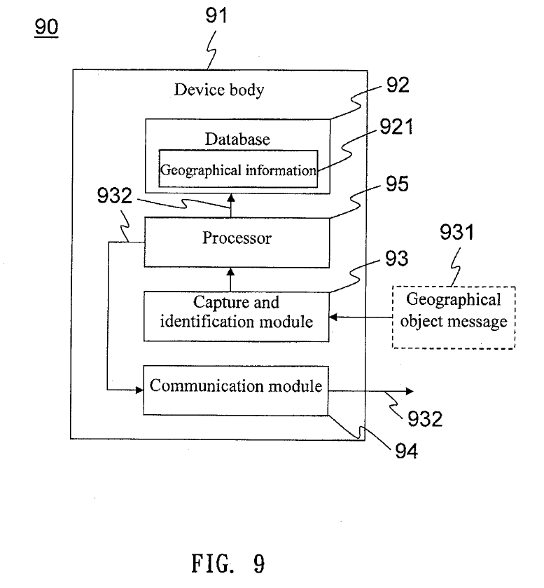

Referring to FIG. 9 for a schematic view of a mobile apparatus of the present invention, the mobile apparatus 90 comprises a device body 91, a database 92, a capture identification module 93, a communication module 94 and a processor 95, wherein the device body 91 provides basic operation functions for the mobile apparatus 90. The database 92, the capture identification module 93, the communication module 94 and the processor 95 are installed in the device body 91. The database 92 stores geographical information 921 of at least one geographical object, and the capture identification module 93 obtains a geographical object message 931 of the geographical object from outside, and identifies the geographical object message 931 to generate an inquiry command 932. The communication module 94 is provided for sending out the inquiry command 932 in order to obtain geographical information from outside. After the processor 95 receives and processes the inquiry command 932, the processor 95 transmits the inquiry command 932 to the database 92 to search the geographical information 921 corresponding to the inquiry command 932, or transmits the inquiry command 932 to the communication module 94.

The mobile apparatus is generally a mobile electronic apparatus, and more specifically a personal digital assistant or a mobile communication apparatus. The capture identification module further comprises a radio frequency reader for obtaining a geographical object message of a geographical object transmitted by a radio frequency signal from outside, or comprises a photography module for photographing an image of the geographical object and taking the image as the geographical object message provided by the geographical object, and further comprises an identification unit for generating an inquiry command after the obtained geographical object message of the geographical object is identified. The identification unit can decode and compare signals or identify and compare images. The database is generally a storage module for storing information relative to the geographical object, such as the floor distribution, building feature, building history, nearby traffic, current position of a bus, and bus route, etc. or stores a lookup table of the geographical information and the inquiry command. The geographical object is generally a building or transportation, and the transportation can be a public transit such as a bus. The geographical information is generally information relative to the geographical object, such as the floor distribution, building feature, building history, nearby traffic, current position of a bus, and bus route, etc. The geographical object message is an identification code or an image, and the identification code is generally a combination of character strings or a barcode, etc., and the geographical object message generally includes an electronic label installed in the geographical object and is sent to the mobile apparatus by a radio frequency signal. The image is generally the appearance of the geographical object photographed by a built-in photography module of the mobile apparatus and taken as the geographical object message provided by the geographical object. Further, the geographical object message of the identification code can be obtained via Internet or a short message, so that users can understand the related geographical information. In the meantime, the mobile apparatus further comprises a navigation module for generating at least one guided route based on the geographical object message. The navigation module comprises an electronic component such as a global positioning system chip for providing a navigation function. The navigation function can be executed based on the geographical information such as longitude and latitude, POI name, the detail addresses, phone numbers and so on.

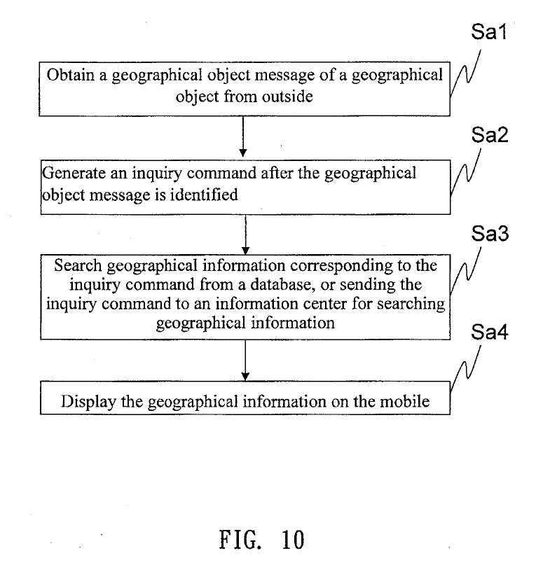

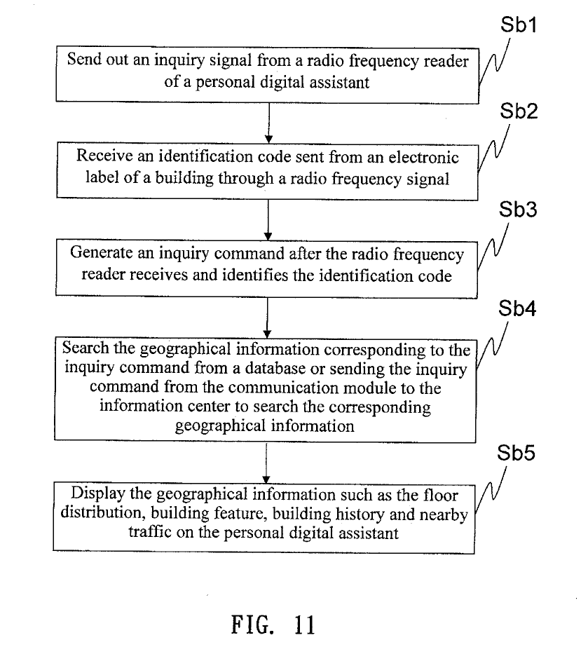

Referring to FIG. 10 for a flow chart of a method of acquiring geographical information of the present invention, the method is applied in a mobile apparatus for displaying geographical information, and comprises the steps of:

Step Sa1: obtaining a geographical object message of a geographical object from outside;

Step Sa2: generating an inquiry command after the geographical object message is identified;

Step Sa3: searching geographical information corresponding to the inquiry command from a database, or searching geographical information corresponding to the inquiry command from an information center based on the inquiry command; and

Step Sa4: displaying the geographical information on the mobile apparatus.

The mobile apparatus is generally a mobile electronic apparatus, and more specifically a personal digital assistant or a mobile communication apparatus, and the geographical object is generally a building or a transportation, and the transportation is a public transit such as a bus. The geographical information is generally information relative to the geographical object, such as the floor distribution, building feature, building history, nearby traffic, current position of a bus, and bus route, etc. The geographical object message can be an identification code or an image, and the geographical object message is obtained from Internet, a short message or a geographical object. The identification code is generally a combination of character strings or a barcode, and the geographical object message is generally transmitted by an electronic label installed in the geographical object to the mobile apparatus through a radio frequency signal. The image, such as the appearance of the geographical object, is generally photographed by a built-in photography module of the mobile apparatus, and taken as a geographical object message provided by the geographical object. The database is generally a storage module for storing information relative to the geographical object, such as the floor distribution, building feature, building history, nearby traffic, current position of a bus, and bus route, etc., or storing a lookup table of the geographical information and the inquiry command. The information center generally includes a geographical information system for providing geographical information corresponding to the inquiry command, such as the floor distribution, building feature, building history, nearby traffic, current position of a bus, and bus route, etc, and also storing a lookup table of the geographical information and the inquiry command. In the meantime, the mobile apparatus further comprises a navigation module for generating at least one guided route based on the geographical object message, and the navigation module comprises an electronic component such as a global positioning system chip for providing a navigation function. The navigation function can be executed based on the geographical information such as longitude and latitude, POI name, the detail addresses, phone numbers and so on.

Referring to FIG. 11 for a flow chart of a method of acquiring geographical information in accordance with a preferred embodiment of the present invention, the method comprises the steps of:

Step Sb1: sending out an inquiry signal from a radio frequency reader of a personal digital assistant;

Step Sb2: receiving an identification code sent from an electronic label of a building through a radio frequency signal;

Step Sb3: generating an inquiry command after the radio frequency reader receives and identifies the identification code;

Step Sb4: searching the geographical information corresponding to the inquiry command from a database based on the inquiry command or sending the inquiry command to the information center by the communication module to search the geographical information corresponding to the inquiry command; and

Step Sb5: displaying the geographical information, such as the floor distribution, building feature, building history and nearby traffic, on the personal digital assistant.

While the invention has been described by way of example and in terms of preferred embodiments, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A geographical information system for acquiring geographical information of a geographical object, comprising:
a geographical object message provided by said geographical object; and
a mobile apparatus for receiving said geographical object message, identifying said geographical object message to produce an inquiry command, searching said geographical information corresponding to said inquiry command from a database of said mobile apparatus based on said inquiry command, and displaying said geographical information on said mobile apparatus.

2. The geographical information system of claim 1, wherein said geographical object is a building or transportation, and said transportation is a public transit, and said public transit is a bus, and said geographical object is photographed by a built-in photography module of said mobile apparatus to become an image that is taken as said geographical object message.

3. The geographical information system of claim 1, wherein said geographical information is information relative to said geographical object.

4. The geographical information system of claim 1, wherein said geographical object message is an identification code or an image, and said geographical object message is transmitted by an electronic label installed in said geographical object to said mobile apparatus through a radio frequency signal.

5. The geographical information system of claim 1, wherein said mobile apparatus is a mobile electronic apparatus, and said mobile electronic apparatus is a personal digital assistant or a mobile communication apparatus.

6. The geographical information system of claim 1, wherein said mobile apparatus further comprises a radio frequency reader for receiving said geographical object message, and said mobile apparatus further comprises a photography module for photographing an image of said geographical object as said geographical object message provided by said geographical object, and said mobile apparatus further comprises an identification unit for identifying said geographical object message provided by said geographical object to produce said inquiry command, and said mobile apparatus further comprises a navigation module for producing at least one guided route based on said geographical object message.

7. The geographical information system of claim 1, wherein said database is a storage module.

8. A geographical information system for acquiring geographical information of a geographical object, comprising:
a geographical object message provided by said geographical object;
a mobile apparatus for receiving said geographical object message, producing an inquiry command after said geographical object message is identified, and sending said inquiry command by a communication module of said mobile apparatus; and
an information center for receiving said inquiry command, searching said geographical information corresponding to said inquiry command, and sending said geographical information to said mobile apparatus for a display thereon.

9. The geographical information system of claim 8, wherein said geographical object is a building or transportation, and said transportation is a public transit, and said public transit is a bus, and said geographical object provides an image of said geographical object photographed by a built-in photography module of said mobile apparatus as said geographical object message.

10. The geographical information system of claim 8, wherein said geographical information is information relative to said geographical object.

11. The geographical information system of claim 8, wherein said geographical object message is an identification code or an image, and said geographical object message is transmitted by an electronic label installed in said geographical object to said mobile apparatus through a radio frequency signal.

12. The geographical information system of claim 8, wherein said geographical object is photographed by a built-in photography module of said mobile apparatus to become an image that is provided as said geographical object message.

13. The geographical information system of claim 8, wherein said mobile apparatus is a mobile electronic apparatus, and said mobile electronic apparatus is a personal digital assistant or a mobile communication apparatus.

14. The geographical information system of claim 8, wherein said mobile apparatus further comprises a radio frequency reader for receiving said geographical object message, and said mobile apparatus further comprises an identification unit for identifying said geographical object message provided by said geographical object to produce said inquiry command, and said mobile apparatus further comprises a navigation module for producing at least one guided route based on said geographical object message.

15. The geographical information system of claim 8, wherein said information center further comprises a geographical information system (GIS) for providing said geographical information corresponding to said inquiry command.

16. A method of acquiring geographical information applied in a mobile apparatus for displaying geographical information, comprising the steps of:
obtaining a geographical object message of a geographical object externally;
identifying said geographical object message, and then producing an inquiry command;
searching said geographical information corresponding to said inquiry command from a database based on said inquiry command, or sending said inquiry command to an information center for searching said geographical information corresponding to said inquiry command; and
displaying said geographical information on said mobile apparatus.

17. The method of acquiring geographical information of claim 16, wherein said geographical object message is obtained from Internet, a short message or an external source for said geographical object, and said geographical object message is an identification code or an image.

18. The method of acquiring geographical information of claim 16, wherein said database is a storage module.

19. The method of acquiring geographical information of claim 16, wherein said information center comprises a geographical information system for providing said geographical information corresponding to said inquiry command.

20. The method of acquiring geographical information of claim 16, wherein said mobile apparatus further comprises a navigation module for generating at least one guided route based on said geographical object message.
